(19) United States
(12) Patent Application Publication
(10) Pub. No.: US 2025/0086775 A1
(43) Pub. Date: Mar. 13, 2025

(54) TOOL MANAGEMENT VEST

(71) Applicant: Honda Motor Co., Ltd., Tokyo (JP)

(72) Inventors: Aaron C FONG, Manhattan Beach, CA (US); Pardeep KUMAR, Kaithal (IN)

(21) Appl. No.: 18/466,706

(22) Filed: Sep. 13, 2023

(51) Int. Cl. G06T 7/00; A41D 1/00; G06F 1/16; G06Q 10/20; G06T 7/194; G06T 7/50

(52) U.S. Cl. CPC G06T 7/0004; A41D 1/002; G06F 1/163; G06Q 10/20; G06T 7/194; G06T 7/50; G06T 2207/10028; G06T 2207/20112

(57) ABSTRACT

The present disclosure relates to a wearable device and more particularly, to a vest management system for identifying broken or damaged equipment or tools within a manufacturing context and providing a notification to replace the equipment. In one illustrative embodiment, the vest may incorporate at least one camera on a forward position. The camera on the vest may scan an environment to detect tools within it. Once a tool is identified, the tool may be inspected to determine whether it is worn or damaged. This may be performed through image mapping or recognition. After identifying a damaged tool, a notification may be provided by the vest to a network administrator where replacement parts may be ordered.

### BACKGROUND

As of September 2023, more than 23,000 associates build products in the United States for Honda. These products include cars, trucks, ATVs, side-by-sides, power equipment, jets and more. These associates engage in industrial plant maintenance, construction work, and the like using a variety of tools to perform tasks. These tasks may include designing parts and maintaining and operating machinery and tools used to produce parts and assemble the products. The machinery and tools may include, for example, angle grinders, forklifts, hand and power tools, hydraulic fluid and fittings, pressure plant and equipment, compressed air and split rims, vehicle hoists, jacks, ramps and stands.

These tools may become damaged, worn out, or broken. In some instances, the damage or imperfections with the tool may be minor or unnoticeable that even the associates themselves do not recognize them. Furthermore, recognizing such situations have not always been easy as associates do not have the capabilities to identify issues on the production line. Reporting such issues may also be difficult to do.

The present disclosure provides for a tool management vest that overcomes the aforementioned challenges. Other benefits and advantages will become clear from the disclosure provided herein and those advantages provided are for illustrative purposes only. The statements in this section merely provide the background related to the present disclosure and does not constitute prior art.

### BRIEF DESCRIPTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a wearable device is provided. The wearable device may include at least one camera and a processor executing one or more instructions stored on memory to perform processes. The processes may include receiving an image from the at least one camera, detecting a tool within the image, identifying whether the tool within the image is damaged, and providing information regarding the tool when the tool has been damaged.

In accordance with another aspect of the present disclosure, a computer program product having a non-transitory computer useable storage medium to store a computer readable program is provided. The computer readable program, when executed on a computer, causes the computer to perform operations. The operations may include receiving an image from a wearable device, detecting whether there is a tool within the image and whether a replacement tool is required, and when the replacement tool is required, identifying a location of the wearable device. In addition, the operations may include providing a notification of the tool and the location.

In accordance with yet another aspect of present disclosure, a tool management system is provided. The system may include at least one wearable device, a memory storing one or more instructions, and a processor executing one or more of the instructions stored on the memory to perform processes. The processes may include receiving an image along with a location from the at least one wearable device, detecting that a tool has been damaged based on the image, tagging the location of the tool that has been damaged.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a schematic diagram of an illustrative vest having at least one camera for tool and issue identification in accordance with one aspect of the present disclosure;

FIG. 2 is a schematic diagram of the illustrative vest placed on an associate in accordance with one aspect of the present disclosure;

FIG. 3 is a schematic diagram of an illustrative manufacturing environment where information may be gathered in accordance with one aspect of the present disclosure;

FIG. 4 is a schematic diagram of the illustrative environment where the associate is able to detect a tool that may have defects in accordance with one aspect of the present disclosure;

FIG. 5 is a schematic diagram of the illustrative tool showing defects or imperfections in accordance with one aspect of the present disclosure;

FIG. 6 is a schematic diagram of an illustrative networked environment whereby the associate may provide information related to the tool in accordance with one aspect of the present disclosure; and

FIG. 7 is a flow diagram showing exemplary processes for locating and identifying issues within tools in accordance with one aspect of the present disclosure.

### DESCRIPTION OF THE DISCLOSURE

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure relates to a wearable device and more particularly, to a vest management system for identifying broken or damaged equipment or tools within a manufacturing context and providing a notification to replace the equipment. In one illustrative embodiment, the vest may incorporate at least one camera on a forward position. The camera on the vest may scan an environment to detect tools within it. Once a tool is identified, the tool may be inspected to determine whether it is worn or damaged. This may be performed through image mapping or recognition. After identifying a damaged tool, a notification may be provided by the vest to a network administrator where replacement parts may be ordered.

Numerous other modifications or configurations to the vest and tool management system will become apparent from the description provided below. For example, while the processing of the image took place on the vest itself, this function may be performed remotely. Advantageously, damaged or worn down equipment may be replaced and exchanged before breaking down on the site saving valuable time and cost. Other advantages will become apparent from the description provided below.

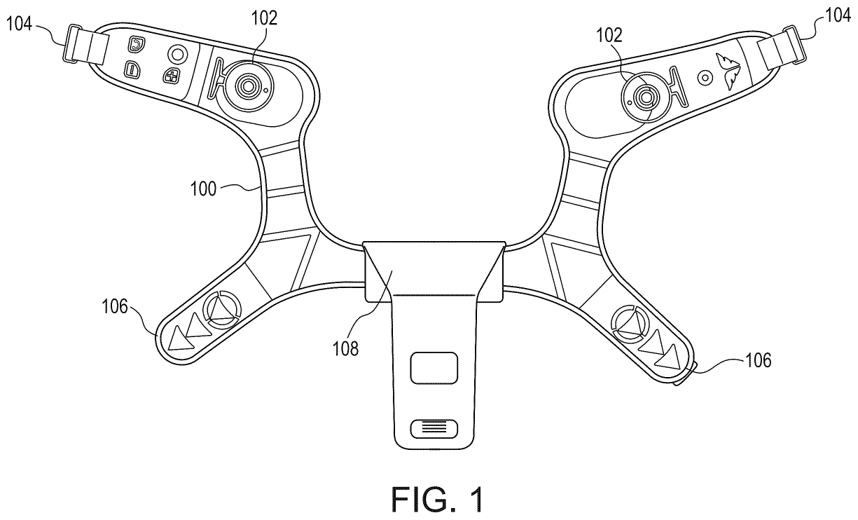

Turning to FIG. 1, a schematic diagram of an illustrative vest 100 having at least one camera 102 for tool and issue identification in accordance with one aspect of the present disclosure is provided. While a vest 100 is used for the identification, other types of wearable devices may be used and should not be limited as such. For example, a hat, cap, glove, body vest, shoe, watch, or the like may be used instead of the vest 100 described herein. Other types of devices may also be used and any such embodiment should not be construed as limiting to the present disclosure.

The vest 100 described herein may provide a number of other features to the associate or user. In one example, the vest 100 may provide heating and cooling properties. This may be performed through air channels within the vest 100 and a heating or cooling pack located on it. In one implementation of the vest 100, it may include an audio and/or visual features which allows the user to listen, speak, or perform other functions with a remote party. In this way, two-way communications may take place allowing real-time instructions to be presented to the wearer of the vest 100. In one embodiment, the vest 100 may also include an emergency beacon or button in situations where the user is hurt or injured. Other features within the vest 100 may be included and are not limited to those described above.

At least one camera 102 may be coupled to a front portion of the vest 100. The camera 102 may be positioned such that when the vest 100 is placed on the user, the camera 102 may point in a field of the view of the user. Thus, what the user sees, the camera 102 may also receive and record. In one embodiment, multiple cameras 102 may be used. By using two or more cameras 102, depth within the image may be determined. A more detailed image from the cameras 102 may be gathered based on this determination of depth of the image.

In one embodiment, the vest 100 may include cameras 102 on the back or side. By doing this, the entirety of the environment in which the vest 100 is located may be scanned. Larger tools may also be analyzed, for example, if the user is in a forklift, the environment may be captured. In one embodiment, if the user is in a large manufacturing plant, the cameras 102 may take images and/or videos of multiple machines or tools within the area such that they may be analyzed.

The vest 100 may include two separate front ends 104 which may be attached to a pair of corresponding back ends 106 such that the vest 100 may be secured to the associate in the manufacturing facility. The front ends 104 may be tethered to the back ends 106 through a fastening mechanism and is not limited to that shown. Multiple straps or other securing mechanisms may be used. The cameras 102 may be positioned on front straps of the vest 100.

Continuing, the vest 100 may include a housing 108 which may provide a number of features. For example, the housing 108 may incorporate a global positioning system that allows the vest 100 to track and provide its location. The location information may be used to determine where the tool broke down through the cameras 102 described above.

In one embodiment, a global positioning system (GPS) device may be used. Each satellite with the GPS may transmit a unique signal and orbital parameters that allow GPS devices to decode and compute the precise location of the satellite. GPS receivers may use this information and trilateration to calculate a user's exact location.

Other types of tracking systems may be used by the vest 100. For example, radio frequency identification (RFID), radio tracking, near-field communication (NFC), geofencing, internet tracking, cellphone triangulation, and rugged asset tracking may also be used. Each may provide a location of the vest 100 and be placed, or a portion thereof, within the housing 108.

Within the housing 108, may be a wireless transmitter and receiver. A computing device with the housing 108 may be capable of providing wired or wireless computer communications utilizing various protocols to send/receive electronic signals internally to/from components of the vest 100. Additionally, the computing device within the vest 100 may be operably connected for internal computer communication via a bus (e.g., a Controller Area Network (CAN) or a Local Interconnect Network (LIN) protocol bus) to facilitate data input and output between the computing device and the components of the vest 100.

The computing device within the housing 108 may include a processor, a memory, a data store, and a communication interface, which are each operably connected for computer communication via a bus and/or other wired and wireless technologies. Through the processor and memory determinations about a tool as captured by the at least one camera 102 may be made on whether the tool is worn out or damaged.

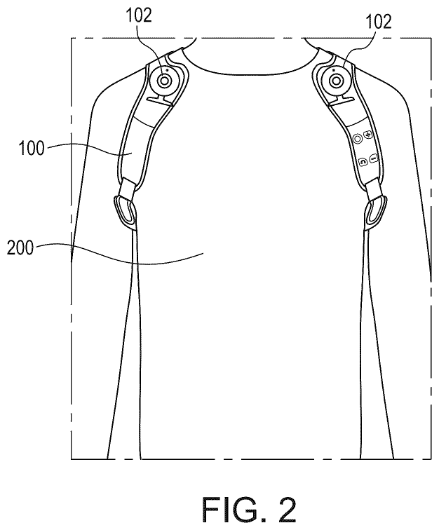

FIG. 2 is a schematic diagram of the illustrative vest 100 placed on an associate 200 in accordance with one aspect of the present disclosure. The vest 100 may be fitted onto the associate 200 like a backpack. The cameras 102 on the vest 100 may face forward and typically at a height of the associate's shoulders. The cameras 102 may be embedded within the vest 100 on a front strap as shown. Through this seamless integration, the cameras 102 may be protected from damage when the vest 102 is placed onto the ground and trampled or stomped on.

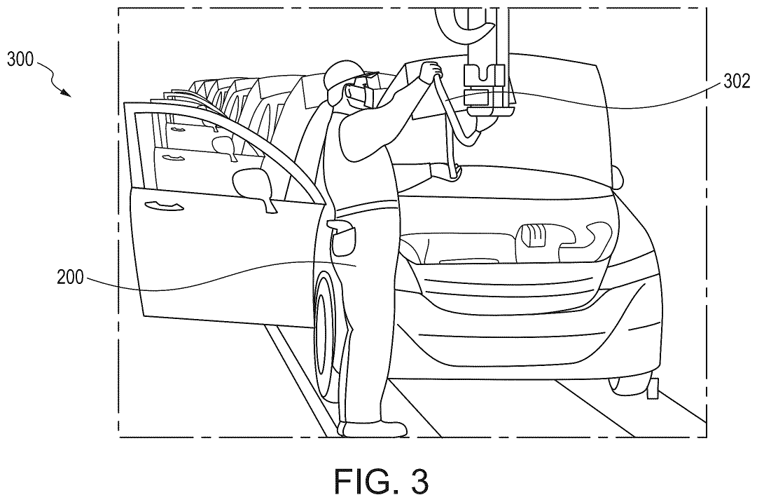

FIG. 3 is a schematic diagram of an illustrative manufacturing environment 300 where information may be gathered in accordance with one aspect of the present disclosure. In the environment 300, the associate 200 may wear the vest (not shown). The vest may be used to capture information about the associate's surroundings, and the like. The associate 200 may typically face the tools 302 that they are working with and using. In the present instance, the tool 302 is a bolt system to tie equipment into the engine area of the vehicle. Some failures that might occur with this type of machinery may include not enough pressure being applied, the gears are grinding down, loose wires may be exposed, the fittings have become too loose, and the like. Through the camera on the vest, these type of defects may be assessed.

Other types of tools may also be analyzed. For example, forklifts may be analyzed within the environment 300. The interior of the forklift may be scanned using the cameras. Other types of tools such as hammers, nails, screwdrivers, and the like may be scanned and determined whether replacements may be needed. Pneumatic drills, conveyor belts, underfloor tracking systems, and the like may also be monitored through the associate's vest and cameras thereon.

In one embodiment, the cameras on the vest may focus on objects automatically. The background environment 300 may be removed in the images and/or videos that were taken. Bounding boxes and such techniques may be used to obtain the tools from the environment 300. In one embodiment, the vest may request the user through speakers on the vest to further investigate if there is an issue with a tool. The instructions may ask that the associate 200 point the camera to the particular issue on the tool 302. Speakers around the associate 200 may also be placed so the user can hear the instructions. These speakers may not be tied to the vest. As shown, real-time information may be given in the environment 300 such that the associate 200 or facilities administrator may fix the issue.

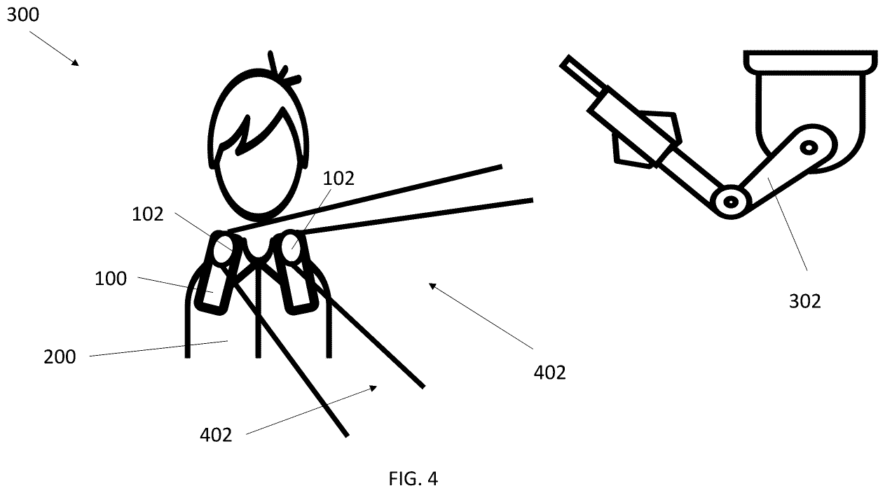

With reference to FIG. 4, a schematic diagram of the illustrative environment 300 where the associate 200 is able to detect a tool 302 that may have defects in accordance with one aspect of the present disclosure is provided. The vest 100, as described earlier, may have at least one camera 102. The camera 102 may be used as though the associate 200 were viewing the issue with the tool 302.

The field of view 402 for the cameras 102 may be positioned right in front of the associate 200. Through the field of views 402 multiple areas within the environment 300 may be captured through videos or images. The cameras 102 may constantly check its surroundings or alternatively be activated when motion is detected. The field of view 402 may capture tools 302 up in the air, to the side of the associate 200, in front of, or at other locations.

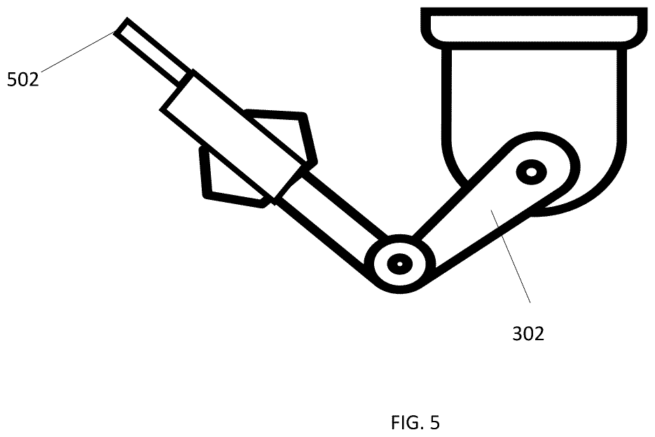

FIG. 5 is a schematic diagram of the illustrative tool 302 showing defects or imperfections in accordance with one aspect of the present disclosure. The tool 302 may for example be a fastener device that may be pulled down from above the vehicle so that entry into the hood of the vehicle may be accessed by the tool 302. Other tools may also be checked or inspected by the vest. In this example, the tool 302 may have a broken or chipped tip 502 that may need replacing or modifications.

The tool 302 may also be checked for how it moves. For example, the tool 302 may have multiple pivoting points. Normal motion may be analyzed and if the tool 302 deviates from this movement, a warning may be given. Video may be captured by the cameras on the vest. In one embodiment, a remaining life of the tool 302 may be determined. This may be determined by the wearing down of the tool and previous statistics.

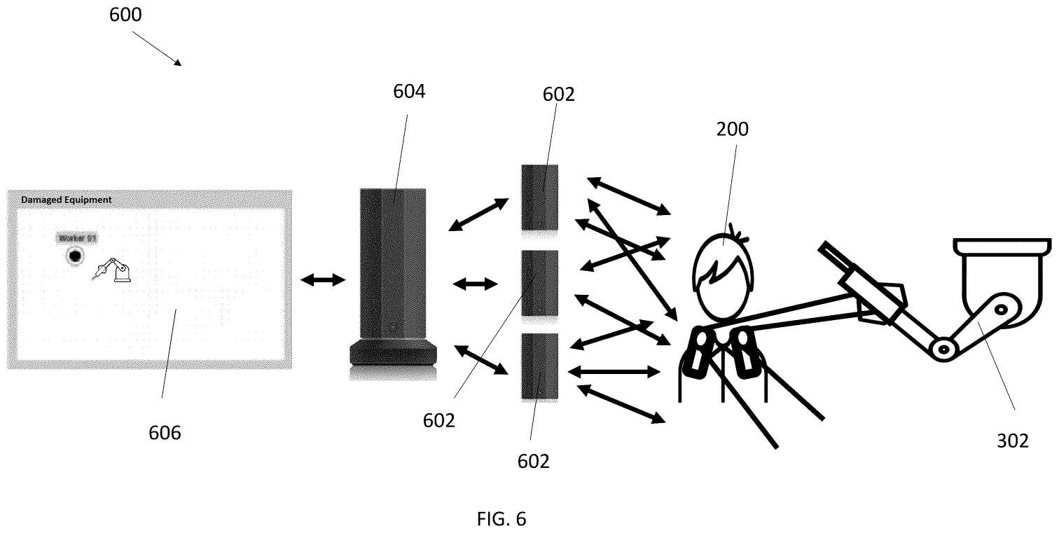

FIG. 6 is a schematic diagram of an illustrative networked environment 600 whereby the associate 200 may provide information related to the tool 302 in accordance with one aspect of the present disclosure. As described earlier, the vest may be used for scanning the tool 302. The vest may be worn by an associate 200 within a manufacturing environment management or factory environment, for example. The camera embedded within the vest may detect whether the tool 302 needs a replacement. A subsequent replacement request may be made through the communication channels shown within the environment 600.

The tool information may be scanned in by the camera and vest of the associate 200. This information along with the location of the associate 200 may be provided to a set of anchor points 602. The anchor points 602 may receive the information from the vest. These points 602 may be provided to a networked server 604 where the information may be processed. The networked server 604 may interact with other anchor points 602 as well. The information that may be processed may include what types of damage or wear that is happening on the tool 302. The information may be shown on the display 606.

In one embodiment, to detect whether the tool 302 has a defect or is damaged, information about the tool 302 may be provided to the associate 200 and their vest. Through this, area or location specific defects with the tool 302 may be determined. For example, only certain types of tools 302 may exist for a user's job in a specific area. Therefore, known issues may be downloaded or used by the system to determine those specific issues that might actually be occurring in the environment 600 for the tool 302.

For example, the specialized tool 302 may be the only tool within a certain area of a manufacturing floor. The information may be downloaded or saved locally on the vest for processing on whether there are issues with the tool 302. Known issues that might often occur may be on the tip of the tool 302 and as such downloaded information about potential causes of problems may be initiated on the vest. A focal point would be to process images on the tip of the tool 302.

In addition, the rotating or moving parts of the tool 302 may have also caused break downs in the past. Image and/or videos of the scans coming from the vest may be matched using the downloaded data. In one example, the way the arm moves may be analyzed based on previous information.

In another embodiment, the information from the vest may be sent to the networked server 604 through the anchor points 602 where the information may be processed. More than one server 604 may exist and a local server may be used which may be tied to the main server. The local server may be more equipped with information about the tool 302 and how it is typically worn out or damaged. In this example, the information would be provided through the vest to the local server 604 and it would be processed there. The local server 604 would have a limited amount of information related to the tools 302 within that area so that data may be processed quicker.

As shown above, the information to determine whether the tool is worn or damaged may be processed locally or remotely. This information may be provided on the display 606 as provided above. The information may include actual video or images of the tool 302. Highlight or pinpointing the defects may be provided. The display 606 may be located in different areas of the manufacturing facility or other locations. Ways to fixup the issue may also be shown.

After the information is provided to the server 604, the information may be processed and useable analytics and statistics may be shown on the display 606. The display may include a touch interface options for ordering parts. Communications between the vest and the display 606 may be provided through microphones and/or speakers on both. The display 606 may provide not only information about broken or worn out tools 302, but analytics and predictions for when the tools may wear out 302. This information may be valuable such that tools 302 or parts for the tools 302 may be preordered before they break down. Facility administrators may be dispatched or allocated for such fix ups through the display 606.

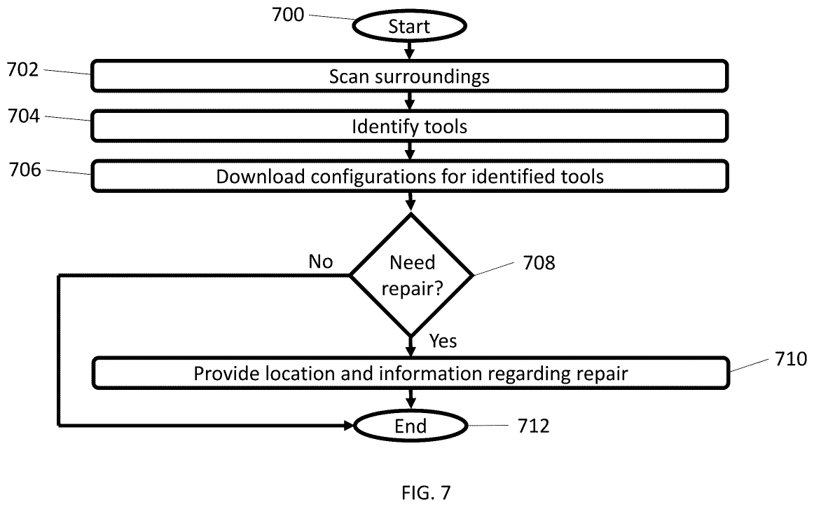

FIG. 7 is a flow diagram showing exemplary processes for locating and identifying issues within tools in accordance with one aspect of the present disclosure. The processes are representative and should not be construed as limiting. The processes may begin at block 700. This may coincide with the vest and/or wearable being activated. In addition, the tracking system should be initiated. The associate may place on the vest and walk around the environment. The environment may include e a number of tools and or other items that are to be inspected and fixed based on images and/or videos taken from the camera on the vest. The vest may be activated by walking into the area for surveillance or otherwise when it is turned on.

At block 702, a scan of the surroundings or environment may be made. Scans may take the form of sweeping scans across the environment from cameras on the vest. The cameras may scan from left to right and up to down. In one embodiment, background images that are not tools may be removed and focus may be given on those by the processor. Shape recognition algorithms may be used. In one example, tool pictures within the area may be downloaded such that the vest when scanning may recognize the tools more easily. Otherwise, this may be performed remotely by the vest sending images onto the server through the anchors.

In one embodiment, the surroundings may be defined as within a narrow confine, or alternatively, the entirety of the space. Geofencing and boundaries may be set for the scan. For example, the vest may be associated with a certain location on a manufacturing floor. The vest may in one embodiment only scan the area that is relevant to that vest. More than one area may be assigned to the vest wearer and each of those areas would be scanned. Outside of those areas, the vest would not scan tools. In this way, this would save processing time by not scanning the entirety of the area.

At block 704, tools may be identified within the scan. The scan may be images and/or videos. Bounding boxes or other techniques may be used to identify the tools within the images and/or videos. In one example, a still image may be captured every couple of seconds. The image may then be parsed with both semantic and syntax segmentation to identify the particular tool in an image, if any. In another example, a tool that is already known is searched through the scan. For example, the specifications of a tool is known within the area that may have already been downloaded into the vest. The vest may then know what it is searching for before even scanning.

Configurations for tools may be identified at block 706, if not performed earlier. Through these configurations, the system may understand and determine if there are any deviations from a working and functioning tool. Comparisons to images taken from scans earlier may be used to identify malfunctioning tools. Images that depict the tool working properly may also be used.

At decision block 708, the vest may determine whether the tool needs repair. The management system which is remote may also perform this function. Image recognition and comparisons may be used to determine whether the tool may break down or is worn out. In one example, if a tip of a tool has become dull, but is still useful, the tool may be labelled as workable however it may need replacement soon. This determination may be made by using the comparisons from the downloaded configurations as described above. In one example, an image match may be made between images that are taken when the tool is damaged and perfect. This matching process may be performed through machine learning or other algorithm.

In one example, a tool replacement module may be executed on the vest or server and include a recognition algorithm that analyzes the captured image of the tool and determines its condition. Varying degrees of damage or being worn out may be useful in determining whether the tool may need to be repaired. If the is no need for a repair, then the processes may end block 712.

Returning to decision block 708, and when a repair is needed, the vest may provide location information about the repair at block 710. The images may have been sent earlier with the location information. The location information may be provided through those techniques described above, for example, the use of GPS technology. A notification regarding the worn-out or damaged tool may be provided to a remote display and be used by a facility administrator. The condition of the tool may be provided including real-time images and/or videos. Previous, or past operating conditions, may also be logged in either locally or remotely using the tool's history. From this information, the age of the tool and/or equipment may be determined.

In one embodiment, and if the tool may be repaired immediately, instructions may be provided through the vest to the associate to fix up the tool. If a repair part is required, the part may be sent immediately through robotic or automated devices. A facility administrator may order new parts through the information that is sent through the vest when a local repair is made by the associate.

The processes may end at block 712. The processes may continuously loop. In embodiment, the loop may occur every few seconds. This may be dependent on the amount of power left on the vest. In another embodiment, a single scan may be made when the user arrives at their dedicated station. The system may end when the associate walks out of their designated area or the system itself is shutdown.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A wearable device comprising:
at least one camera; and
a processor executing one or more instructions stored on memory to perform:
receiving an image from the at least one camera;
detecting a tool within the image;
identifying whether the tool within the image is damaged;
providing information regarding the tool when the tool has been damaged.

2. The wearable device of claim 1, wherein the at least one camera is embedded within the wearable device.

3. The wearable device of claim 1, wherein the at least one camera is positioned on a front strap of the wearable device.

4. The wearable device of claim 1, comprising two cameras for detecting a depth of the image.

5. The wearable device of claim 1, wherein the processor executing the one or more instructions stored on the memory further performs retrieving data for a set of tools.

6. The wearable device of claim 5, wherein retrieving the data for the set of tools comprises determining a location of the wearable device and associating the set of tools with the location.

7. The wearable device of claim 1, wherein detecting the tool within the image comprises removing background environmental objects from the image.

8. The wearable device of claim 1, wherein identifying whether the tool within the image is damaged comprises analyzing a condition of the tool as being useable or not useable.

9. The wearable device of claim 1, wherein identifying whether the tool within the image is damaged comprises analyzing a remaining life of the tool.

10. The wearable device of claim 1, wherein providing information regarding the tool when the tool has been damaged comprises sending a replacement report containing information about the tool with the identified damage.

11. A computer program product comprising a non-transitory computer useable storage medium to store a computer readable program that, when executed on a computer, causes the computer to perform operations comprising:
receiving an image from a wearable device;
detecting whether there is a tool within the image and whether a replacement tool is required;
when the replacement tool is required, identifying a location of the wearable device; and
providing a notification of the tool and the location.

12. The computer program product of claim 11, wherein the wearable device is within a manufacturing environment.

13. The computer program product of claim 11, wherein receiving the image from the wearable device comprises obtaining the image from a centralized computer system which is in communication with a plurality of anchors that sense the wearable device.

14. The computer program product of claim 11, wherein detecting whether a replacement tool is required comprises searching through a database of images to determine whether the tool needs repairs.

15. The computer program product of claim 11, wherein detecting whether a replacement tool is required comprises determining whether the tool is worn out or damaged.

16. The computer program product of claim 11, wherein the computer readable program, when executed on the computer, causes the computer to perform operations to order the replacement tool.

17. The computer program product of claim 16, wherein the computer readable program, when executed on the computer, causes the computer to perform operations to provide the replacement tool to the location when the order is received.

18. The computer program product of claim 11, wherein the notification includes a condition of the tool.

19. A tool management system comprising:
at least one wearable device;
a memory storing one or more instructions; and
a processor executing one or more of the instructions stored on the memory to perform:
receiving an image along with a location from the at least one wearable device;
detecting that a tool has been damaged based on the image;
tagging the location of the tool that has been damaged.

20. The tool management system of claim 19, wherein the processor executing the one or more of the instructions stored on the memory to perform processes further comprises providing instructions to the wearable device to gather additional information about the tool.
